(19) United States
(12) Patent Application Publication
(10) Pub. No.: US 2025/0334724 A1
(43) Pub. Date: Oct. 30, 2025

(54) HIGHLY TRANSPARENT RETRO-REFLECTIVE SHEETS WITH BROAD SPECTRAL RANGE FOR DIVERSE APPLICATIONS

(71) Applicant: Neale O L E Haugen, Madison, WI (US)

(72) Inventor: Neale O L E Haugen, Madison, WI (US)

(21) Appl. No.: 18/764,434

(22) Filed: Jul. 5, 2024

(51) Int. Cl. G02B 5/124

(52) U.S. Cl. CPC G02B 5/124

(57) ABSTRACT

The present invention relates to a highly transparent retro-reflective sheet for achieving broad-spectrum light reflection in applications such as cryogenic storage, high-intensity laser systems, and directed energy weapon (DEW) shielding. The highly transparent retro-reflective sheet comprises a sheet body, an optical structure surface and a reflecting surface. The highly transparent retro-reflective sheet is capable of broad-spectrum light reflection with minimal absorption for maximum efficiency, and is able to withstand high-powered laser beams without damage. The highly transparent retro-reflective sheet is disposed on objects to reflect away light or radiation directed towards the objects, thereby enabling the highly transparent retro-reflective sheet to be applicable for diverse applications such as space-based cryogen storage, superior reflective layers for vacuum insulation, high-intensity laser beam reflectors for beam-propelled space travel, and optical and infrared shielding from directed energy weapons (DEW).

### FIELD OF THE INVENTION

The present disclosure relates generally to reflective materials, and more particularly to highly transparent retro-reflective sheets for achieving broad-spectrum light reflection in applications such as cryogenic storage, high-intensity laser systems, and directed energy weapon shielding.

### BACKGROUND

Optics is a field that has been focused on creating mirrors that can reflect light across a wide range of wavelengths. Over time, improvements in mirror technology have transformed several domains, including astronomy and optical instrumentation. Nevertheless, traditional mirrors still have some drawbacks.

Conventional metallic mirrors, such as those typically used in everyday applications, have certain limitations in their reflective properties. They tend to reflect light well over a broad range of wavelengths, but their reflectivity is not perfect and some light is still absorbed. Typically, on the order of 1-10% even for the best conventional mirrors. This relatively large amount of absorption can be a problem in many applications that require higher levels of reflectivity.

Better than conventional mirrors are dielectric mirrors which typically consist of a stack of different dielectric materials arranged in a specific series of thin layers with highly controlled thicknesses. They tend to reflect light very efficiently, but only within a narrow range of wavelengths. Outside that narrow bandwidth dielectric mirrors tend to be less effective for reflecting light. This restricted range of reflectivity can be a challenge in many applications that require efficient light manipulation across a wider range of wavelengths. Super mirrors strive to combine high reflectivity with a broader wavelength range, however for certain applications these too fall short with reflectivity of only 99.97% or less, and relatively narrow wavelength ranges compared with metallic mirrors.

In the field of laser beam propulsion, highly reflective mirrors play a crucial role in directing and reflecting laser beams to generate thrust. However, conventional metallic mirrors and dielectric mirrors with narrowband reflectivity have their limitations. When exposed to high-intensity laser beams, metallic mirrors can be damaged due to partial absorption of light, which can cause them to overheat and potentially shatter. Furthermore, as the propelled craft accelerates, the laser beam's frequency will shift (redshift) due to the Doppler effect. This shift can cause the light to fall outside the highly reflective band of a typical dielectric mirror or even a supermirror, thereby leading to a significant drop in efficiency or even damage to the mirror itself.

Similarly, in space applications, it is crucial to have effective sun shields to safeguard satellites, cryogenic fuel and coolant storage tanks, and other delicate equipment from harmful solar radiation. However, the current technology for sun shields often relies on complex and expensive materials with multi-layered structures. A prime example is the James Webb Space Telescope (JWST) sunshield, which utilizes a five-layer Kapton sail coated with reflective aluminum and a specialized polymer film to achieve its remarkable heat rejection capabilities. While highly effective, the JWST sunshield's complexity and cost highlight the need for more accessible solutions for various sun shield applications. These materials are unable to fully protect against the entire solar spectrum, which includes visible, infrared, and ultraviolet light due to partial absorption of the light. Insufficient shielding can lead to higher minimum achievable temperatures and thus faster boil off of irreplaceable cryogens, inefficiencies in thermal management, potential damage to the protected equipment, and can even cut short the lifespan of a satellite or space probe's mission.

Furthermore, with advancements in Directed Energy Weapon (DEW) technology, robust defense mechanisms are becoming increasingly important. At the power levels of many high energy laser (HEL) based DEWs, conventional metallic mirrors are easily destroyed, and dielectric mirrors suffer from limitations including narrowband reflectivity cost and a lack of robustness. This means they may be susceptible to specific DEW frequencies or high-powered laser attacks that overwhelm their reflective capabilities.

To address all the above-mentioned limitations, there is a need for highly transparent retro-reflective sheets for achieving broad-spectrum light reflection in applications such as cryogenic storage, high-intensity laser systems, and directed energy weapon shielding. There is a need for highly transparent retro-reflective sheets capable of broad-spectrum light reflection with minimal absorption for maximum efficiency, and to withstand high-powered laser beams without damage.

### SUMMARY OF THE INVENTION

The following presents a simplified summary of one or more embodiments of the present disclosure to provide a basic understanding of such embodiments. This summary is not an extensive overview of all contemplated embodiments and is intended to neither identify key nor critical elements of all embodiments nor delineate the scope of any or all embodiments.

The present disclosure, in one or more embodiments, relates to a highly transparent retro-reflective sheet for achieving broad-spectrum light reflection in applications such as cryogenic storage, high-intensity laser systems, and directed energy weapon shielding. The highly transparent retro-reflective sheet is capable of broad-spectrum light reflection with minimal absorption for maximum efficiency, minimum thermal load, and to withstand high-powered laser beams without damage. In one embodiment herein, the highly transparent retro-reflective sheet comprises a sheet body, an optical structure surface and a reflecting surface.

In one embodiment herein, the sheet body is made of a highly transparent material. The sheet body having a minimum thickness to minimize a length of a light path for preventing input light absorption while still affording a suitable degree of robustness to shocks and vibrations. In one embodiment herein, the highly transparent material is a low OH and or fluorine doped fused silica.

In some embodiments, the highly transparent material includes at least one of a Barium Fluoride (BaF2), Cadmium Telluride (CdTe), Calcium Fluoride (CaF2), Fused Silica (SiO2), Gallium Arsenide (GaAs), Germanium (Ge), Intrinsic Silicon (Si), IR Polymer, Thallium Bromo-Iodide (KRS-5), Lead Fluoride (PbF2), Magnesium Fluoride (MgF2), Magnesium Oxide (MgO), N-BK7, Potassium Bromide (KBr), Sapphire (Al2O3), Sodium Chloride (NaCl), zirconium-barium-lanthanum-aluminum fluoride (ZBLAN), Zinc Oxide (ZnO), Zinc Selenide (ZnSe), Zinc Sulphide (ZnS), and any other solid material with similarly broadband high transparency.

In one embodiment herein, the optical structure surface is disposed on one side of the sheet body. The optical structure surface is configured to pass an input light from one or more light sources.

In one embodiment herein, the reflecting surface is disposed opposite to the optical structure surface. The reflecting surface is configured to totally internally reflect the input light passed through the optical structure surface across a broad spectrum as a reflected light, thereby achieving retro-reflectivity with a minimum of light absorption by the highly transparent retro-reflective sheet.

In one embodiment herein, the reflecting surface comprises a plurality of reflecting elements. Each reflecting element comprises at least one of a corner cube structure, a trihedral pyramid structure, and geometrical structures that capable of achieving the retro-reflectivity.

In one embodiment herein, the plurality of reflecting elements is patterned on the reflecting surface of the sheet body using one or more methods including a cutting method, an etching method such as lithographic wet or dry etching, a pressing method, an imprinting method, a molding method, forming from the molten or semifluid state such as forming warm glass above its glass transition temperature, and any form of vapor deposition methods including Physical Vapor Deposition (PVD), Chemical Vapor Deposition (CVD), Plasma-Enhanced Chemical Vapor Deposition (PECVD), Metal Organic Chemical Vapor Deposition (MOCVD), and similar methods.

In one embodiment herein, the highly transparent retro-reflective sheet further comprises a low-emissivity coating applied to the reflecting surface, specifically designed to minimize thermal radiant emission from the reflecting surface, thereby achieving an asymmetrical emission of thermal radiation without significantly enhancing the reflectivity of the highly transparent retro-reflective sheet.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

The accompanying drawings, which are incorporated in and constitute a part of the specification, illustrate an embodiment of the invention, and, together with the description, explain the principles of the invention.

FIG. 1 illustrates a side view of a highly transparent retro-reflective sheet, in accordance with embodiments of the invention.

FIG. 2 illustrates a top view of the highly transparent retro-reflective sheet with a corner cube configuration, in accordance with embodiments of the invention.

FIG. 3 illustrates a top view of the highly transparent retro-reflective sheet with a trihedral pyramid configuration, in accordance with embodiments of the invention.

FIG. 4 illustrates a graphical representation of an attenuation spectrum of fused silica, in accordance with embodiments of the invention.

FIG. 5 illustrates a graphical representation depicting a number of other highly transparent materials which could potentially be used to fabricate the highly transparent retro-reflective sheet, in accordance with embodiments of the invention.

### DETAILED DESCRIPTION

Reference will now be made in detail to the present preferred embodiments of the invention, examples of which are illustrated in the accompanying drawings. Wherever possible, the same reference numerals are used in the drawings and the description to refer to the same or like parts.

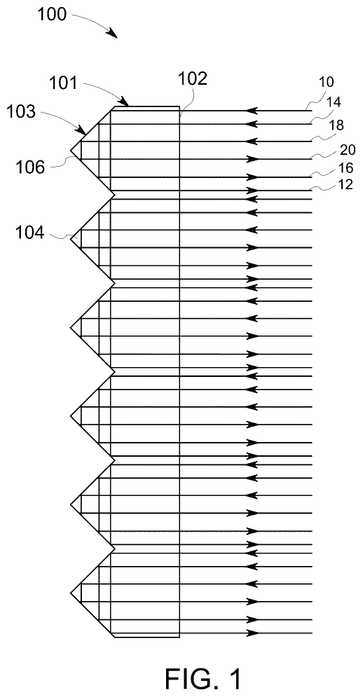

According to an exemplary embodiment, the invention discloses a highly transparent retro-reflective sheet 100 (shown in FIG. 1) for achieving broad-spectrum light reflection with applications in cryogenic storage, beam propelled light sailing, and directed energy weapon (DEW) shielding specifically shielding from high energy laser systems (HELs). The highly transparent retro-reflective sheet 100 is capable of broad-spectrum light reflection with minimal absorption for maximum efficiency, so as to withstand high-powered laser beams without damage.

FIG. 1 refers to a side view of the highly transparent retro-reflective sheet 100. In one embodiment herein, the highly transparent retro-reflective sheet 100 comprises a sheet body 101, an optical structure surface 102 and a reflecting surface 103. In one embodiment herein, the sheet body 101 is made of a highly transparent material. The sheet body 101 comprises a minimum thickness that varies between 1 micron and 5 mm with a preferred thickness of 0.1 mm, to minimize a length of a light path for preventing input light absorption while still affording a suitable degree of robustness to shocks and vibrations. In one embodiment herein, the highly transparent material is a low OH and or fluorine doped fused silica such as Supersil 3001+3002, which is commonly used in high-performance optical fibers for excellent transparency across a broad visible and near-infrared spectrum.

In other embodiments, the highly transparent material includes at least one of a Barium Fluoride, Cadmium Telluride, Calcium Fluoride, Fused Silica, Gallium Arsenide, Germanium, doped or undoped Silicon, IR Polymers, KRS-5 (Thallium Bromo-Iodide), Lead Fluoride, Magnesium Fluoride, Magnesium Oxide, N-BK7, Potassium Bromide, Sapphire, Sodium Chloride, zirconium-barium-lanthanum-aluminum fluoride ZBLAN, Zinc Oxide, Zinc Selenide, Zinc Sulphide, or virtually any other solid material with similarly broadband high transparency.

In one embodiment herein, the optical structure surface 102 is disposed on one side of the sheet body 101. The optical structure surface 102 is configured to pass an input light (10, 14, 18) from one or more light sources. The chance of the input light (10, 14, 18) being absorbed and converted to heat inside the highly transparent retro-reflective sheet 100 is minimized by reducing the length of the light path, and minimizing the absorption of the light by the material.

In one embodiment herein, the reflecting surface 103 is disposed opposite to the optical structure surface 102. The reflecting surface 103 is configured to totally internally reflect the input light passed through the optical structure surface 102 across a broad spectrum as a reflected light, thereby achieving retro-reflectivity with a minimum of light absorption by the highly transparent retro-reflective sheet 100.

In one embodiment herein, the reflecting surface 103 further comprises a specialized low-emissivity coating 106, which is configured to emit thermal radiation. The low-emissivity coating 106 can minimize the amount of thermal radiation emitted by the highly transparent retro-reflective sheet 100, thereby making the reflector even more effective at blocking incoming thermal radiation.

In one embodiment herein, the reflecting surface 103 of the sheet body 101 is patterned with a plurality of reflecting elements 104. In one embodiment herein, the plurality of reflecting elements is patterned on the reflecting surface of the sheet body using one or more methods including a cutting method, an etching method such as lithographic wet or dry etching, a pressing method, an imprinting method, a molding method, forming from the molten or semifluid state such as forming warm glass above its glass transition temperature, and any form of vapor deposition methods including Physical Vapor Deposition (PVD), Chemical Vapor Deposition (CVD), Plasma-Enhanced Chemical Vapor Deposition (PECVD), Metal Organic Chemical Vapor Deposition (MOCVD), and similar methods.

In one embodiment herein, each reflecting element 104 can be a corner cube reflector, which is in a three-sided pyramid shape formed by three flat surfaces at right angles to each other. In some embodiments herein, the plurality of reflecting elements 104 can be a trihedral pyramid reflector with a triangular base and three other triangular sides.

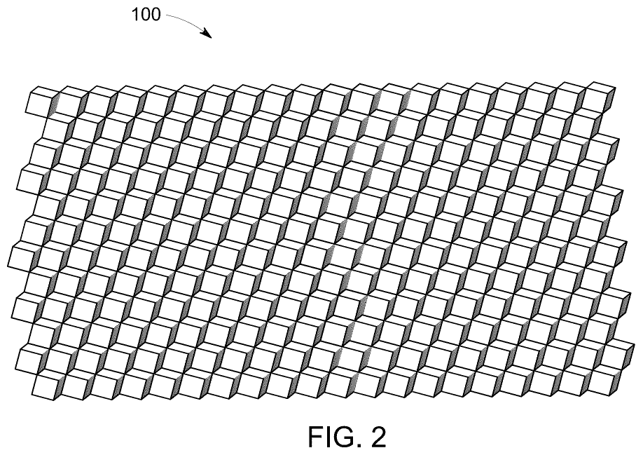

In one embodiment herein, the reflecting elements 104 are configured to reflect the input light (10, 14, 18) as reflected light (12, 16, 20) at an angle when the input light (10, 14, 18) emitted from the light sources is entered through the optical structure surface 102, and strikes to at least two of the plurality of reflecting elements 104 at an angle greater than the critical angle for total internal reflection (TIR) as shown in FIG. 2. The reflected light (12, 16, 20) then passes back through the optical structure layer 102 and exits the reflector at an angle close to the incident angle. The highly transparent retro-reflective sheet 100 effectively reflects the input light (10, 14, 18) in a direction and achieves retro-reflectivity with a minimum of absorption.

In one embodiment herein, the plurality of reflecting elements 104 are configured to cause the total internal reflection (TIR) for the input light (10, 14, 18). The TIR occurs when the input light (10, 14, 18) travels from a high refractive index to a lower refractive index of the optical structure surface 102. The TIR occurs when the angle of the input light (10, 14, 18) striking the plurality of reflecting elements 104 is greater than a certain critical angle. The input light (10, 14, 18) gets completely reflected back as reflected light (12, 16, 20) instead of passing through the highly transparent retro-reflective sheet 100 as transmitted light, thereby achieving reflectivity with a minimum of absorption for the functioning of the highly transparent retro-reflective sheet 100.

In one exemplary embodiment herein, the design of the plurality of reflecting elements 104 allows them to achieve the TIR across a broad spectrum of light, thereby enabling the highly transparent retro-reflective sheet 100 to effectively reflect the input light (10, 14, 18) with wavelengths ranging from deep UV i.e. shorter wavelengths to the mid or even far-infrared range i.e. longer wavelengths depending on the materials employed. This broad spectrum capability (at least 5 9's reflectivity from wavelengths of 300 nm to 2000 nm), and ultrahigh reflectivity (up to 8 9's reflectivity for common materials), is a significant advantage compared to conventional metallic mirrors or dielectric mirrors that often have absorption or a narrow range of wavelengths for which the mirror is reflective.

FIG. 2 refers to a top view of the highly transparent retro-reflective sheet 100 with the corner cube configuration. The reflecting surface 103 (shown in FIG. 1) is patterned with a grid of tiny corner cube reflectors. These reflectors are patterned on the reflecting surface 103 of the sheet body 101 to create a precise arrangement of triangular shapes. Each corner cube reflector is made up of three reflective surfaces that meet at right angles to each other.

When the light hits the highly transparent retro-reflective sheet 100, it travels through the optical structure surface 102 (shown in FIG. 1) and encounters the corner cube reflector. If the light strikes the reflector at an angle greater than the critical angle for total internal reflection, it may bounce off all three reflective surfaces of the corner cube and travel back in the direction it came from, thereby achieving the retro reflection of the highly transparent retro-reflective sheet 100. The corner cube reflectors are very small and closely spaced together, thereby providing a uniform appearance for the highly transparent retro-reflective sheet 100. The size and spacing of the reflectors are carefully chosen to optimize the light reflection properties of the highly transparent retro-reflective sheet 100 across a broad spectrum of wavelengths.

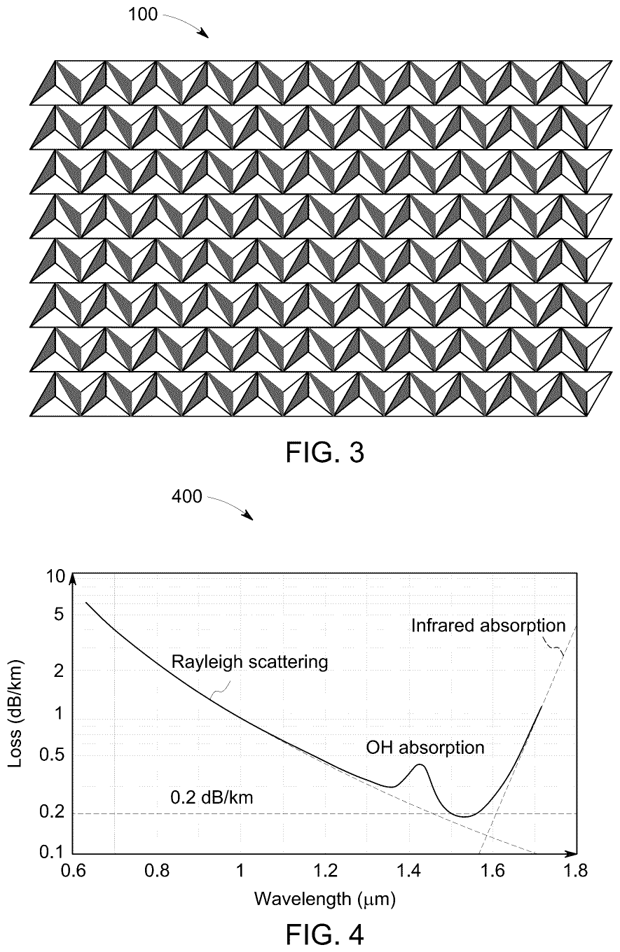

FIG. 3 refers to a top view of the highly transparent retro-reflective sheet 100 with the trihedral pyramid configuration. The reflecting surface 103 (shown in FIG. 1) is patterned with a grid of tiny trihedral pyramid reflectors. These reflectors are patterned on the reflecting surface 103 of the sheet body 101 to create a precise arrangement of triangular shapes. Each trihedral pyramid reflector has a triangular base and three other triangular sides.

When the light hits the highly transparent retro-reflective sheet 100, it travels through the optical structure surface 102 (shown in FIG. 1) and encounters a trihedral pyramid reflector. If the light strikes the reflector at an angle greater than the critical angle for total internal reflection, it will bounce off all three triangular sides of the pyramid and travel back in the direction it came from, thereby achieving the retro reflection of the highly transparent retro-reflective sheet 100. The trihedral pyramid reflectors are very small and closely spaced together, thereby providing a uniform appearance for the highly transparent retro-reflective sheet 100. The size and spacing of the reflectors are carefully chosen to optimize the light reflection properties of the highly transparent retro-reflective sheet 100 across a broad spectrum of wavelengths.

FIG. 4 refers to a graphical representation 400 of an attenuation spectrum of fused silica. The graph 400 shows the amount of light signal lost (attenuated) over a range of wavelengths, typically measured in decibels per kilometer (dB/km). The y-axis shows the amount of light signal lost (attenuated) in decibels per kilometer (dB/km). Higher values indicate more signal loss. The x-axis shows the wavelength of light in micrometers (μm). The curve represents the attenuation coefficient as a function of wavelength. It shows that attenuation is generally lower in the visible and near-infrared regions, which is around 0.6 to 1.8 μm and increases significantly in the ultraviolet and infrared regions. Other materials such as Potassium Bromide (KBr) could provide high reflectivity with low absorption over an even broader spectrum (250 nm to 30 microns). A plethora of such high transparency materials exist and each may find its use in various embodiments of these reflector sheets.

The graph 400 shows Rayleigh scattering, which is the main source of attenuation at shorter wavelengths around 0.2 to 0.6 μm. It is caused by the scattering of light by microscopic irregularities in the material. The graph 400 shows OH absorption, which is a peak in the attenuation curve around 1.4 μm caused by the presence of hydroxyl (OH) groups in the silica. The graph 400 also shows infrared absorption, which refers to the increase in attenuation at longer wavelengths i.e. greater than 1.6 μm. It is caused by the absorption of light by the vibrational modes of the silica molecules. The region between approximately 1.1 μm and 1.6 μm is known as the low-loss window for fused silica.

The low OH fused silica and KBr exhibit generally good performance across the entire wavelength range. The attenuation stays relatively low for most wavelengths, thereby indicating good light transmission by the highly transparent retro-reflective sheet 100. The low OH fused silica shows a gradual increase in attenuation as the wavelength increases, thereby suggesting slightly more light is absorbed at longer wavelengths compared to shorter wavelengths. The KBr generally provides approximately equal performance but over a wider spectral range. It is less robust than fused silica and has a lower melting temperature, but may be useful in certain applications where fused silica may not be suitable.

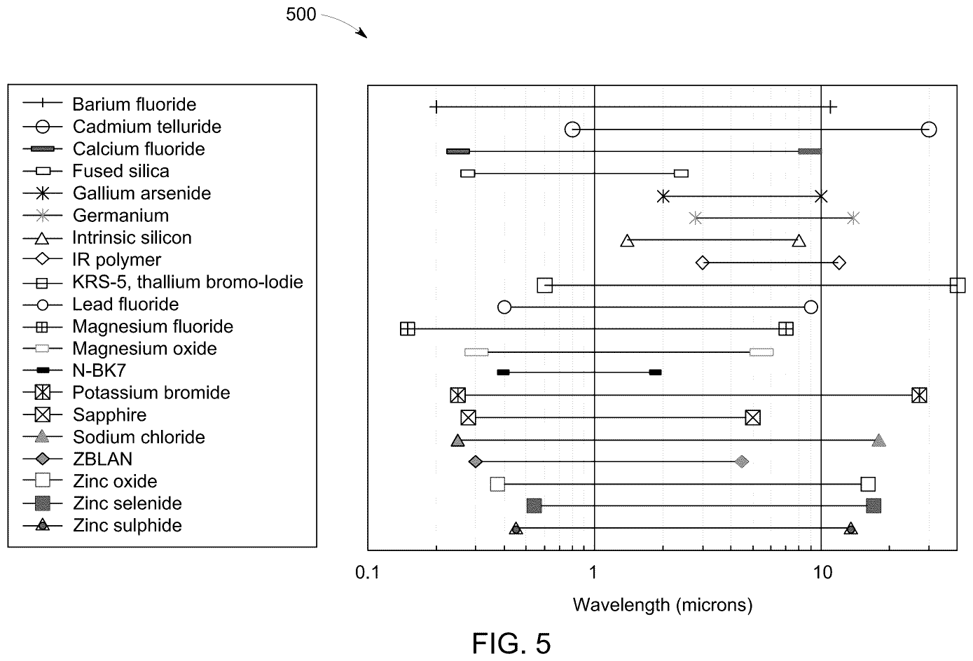

FIG. 5 refers to a graphical representation 500 depicting a number of other highly transparent materials which could potentially be used to fabricate the highly transparent retro-reflective sheet 100. Each material has a different range of wavelengths it transmits efficiently, which is important for different applications. The x-axis of the graph 500 represents the range of light wavelengths across the ultraviolet (UV), visible (VIS), and infrared (IR) spectrum.

The graph 500 shows the highly transparent materials and their corresponding transparent regions. For example, Barium Fluoride (BaF2) is transparent from 0.2 μm to 11 μm, Cadmium Telluride (CdTe) is transparent from 0.8 μm to 30 μm, Calcium Fluoride (CaF2) is transparent from 0.25 μm to 10 μm, Fused Silica (SiO2) is transparent from 0.28 μm to 2.5 μm, Gallium Arsenide (GaAs) is transparent from 2 μm to 10 μm, Germanium (Ge) is transparent from 2.8 μm to 16 μm, Intrinsic Silicon (Si) is transparent from 1.5 μm to 8 μm, IR Polymer is transparent from 3 μm to 15 μm, Thallium Bromo-Iodide (KRS-5) is transparent from 0.6 μm to 40 μm, Lead Fluoride (PbF2) is transparent from 0.4 μm to 9 μm, Magnesium Fluoride (MgF2) is transparent from 0.15 μm to 7 μm, Magnesium Oxide (MgO) is transparent from 0.3 μm to 6 μm, N-BK7 is transparent from 0.4 μm to 1.8 μm, Potassium Bromide (KBr) is transparent from 0.25 μm to 25 μm, Sapphire (Al2O3) is transparent from 0.2 μm to 5 μm, Sodium Chloride (NaCl) is transparent from 0.3 μm to 20 μm, ZBLAN is transparent from 0.3 μm to 4.0 μm, Zinc Oxide (ZnO) is transparent from 0.35 μm to 4 μm, Zinc Selenide (ZnSe) is transparent from 0.4 μm to 14 μm, and Zinc Sulphide (ZnS) is transparent from 0.35 μm to 4 μm.

For instance, fused silica can be suitable for applications that require transparency across a broad range of the UV-visible-infrared spectrum. However, fused silica may not be the best option for applications that require high transparency at very short or very long wavelengths. Different materials would be useful for different portions of the UV-Visible-Infrared spectrum. Also various materials may present various differing advantages and disadvantages for various applications of the highly transparent retro-reflective sheet 100.

In one exemplary embodiment, the highly transparent retro-reflective sheet 100 is applicable for cryogenic storage vessels, which are used to store cryogenic substances such as liquefied natural gas, liquefied helium 3, and rocket propellants at extremely low temperatures. The highly transparent retro-reflective sheet 100 is positioned adjacent to the cryogenic storage vessels to reflect light away from the vessels, thereby minimizing the amount of heat the vessel gains from its surroundings. This passive cooling maintains the cryogenic substances, for example, liquid helium at low temperatures for long-term storage in space. In one embodiment herein, the highly transparent retro-reflective sheet 100 is also applicable for cooling detectors, satellites, and thereof. In one such embodiment, the application of a low emissivity coating 106 on the outer surface of the reflecting layer 103 might provide further cooling due to anisotropic thermal radiation emission.

In another exemplary embodiment, the highly transparent retro-reflective sheet 100 is placed inside the vacuum chamber of a flask, and the patterned side of the plurality of reflecting elements 104 is faced outwards from the hot reservoir. The highly transparent retro-reflective sheet 100 minimizes heat loss compared to traditional metallic coatings by reflecting thermal infrared radiation back towards the hot object, thereby significantly improving the flask's insulating properties to keep hot beverages or food warmer for longer durations.

In another exemplary embodiment, the highly transparent retro-reflective sheet 100 is applicable for solar sails due to the combination of high transparency and broad spectral range. As the highly transparent retro-reflective sheet 100 is highly transparent, it allows nearly all of the light to be reflected with almost no absorption, thereby preventing excessive heat buildup within the highly transparent retro-reflective sheet 100 itself, thereby eliminating the risk of vaporization or melting or other damage from high-powered lasers used to propel massive spacecraft at meaningful accelerations. The broad spectral range of the highly transparent retro-reflective sheet 100 allows it to reflect light effectively even with a large redshift, which means the solar sails using the highly transparent retro-reflective sheet 100 may potentially reach higher speeds before the redshift effect reaches the limit of the reflector's reflective region (for fused silica 2-3 microns of wavelength, which is approximately 4.5 times the wavelength of a blue laser diode that is 0.45 microns). This large transparent range allows for the reflector to still function normally even when the incoming light has a redshift z-factor or 4 or more. This level of redshift corresponds to speeds exceeding 90% of the speed of light.

In one exemplary embodiment, the highly transparent retro-reflective sheet 100 is applicable for protecting objects against directed energy weapons (DEW), which are high-energy lasers (HELs) used as weapons. The highly transparent retro-reflective sheet 100 is placed on the objects to reflect the DEW radiation away from the objects, thereby protecting the objects from the damaging effects of the laser beams. The objects can be, but are not limited to, military vehicles, missiles, airplanes, buildings, roads, decks and supports of bridges, communication towers, helmets, airstrips, and thereof.

In one embodiment herein, the highly transparent retro-reflective sheet 100 reflects DEW radiation away from objects, thereby potentially protecting them from laser attacks. The highly transparent retro-reflective sheet 100 handles high-intensity light from lasers, thereby potentially improving efficiency and allowing solar sails (beam propelled light sailing) to utilize higher beam intensities. The highly transparent retro-reflective sheet 100 offers superior protection for both hot and cold objects by reflecting infrared radiation in vacuum for thermal management purposes such as cryogenic storage and acts as a DEW shield in air, water or space.

Overall, the highly transparent retro-reflective sheet 100 represent a significant advancement over both conventional metallic mirrors and super mirrors in terms of achieving high reflectivity across a broad spectral range with minimal absorption. This makes them particularly suitable for demanding applications where efficiency, durability, and versatility are paramount. The ability to achieve extremely low temperatures, such as potentially as low as 3 Kelvin, with the highly transparent retro-reflective sheet 100 represents a significant advancement in space sunshield technology. This capability contrasts sharply with conventional sunshields, which typically struggle to maintain temperatures below approximately 50 Kelvin.

The highly transparent retro-reflective sheet 100 is designed to maintain their functionality even with significant redshifts in the incoming light, which allows for effective operation at very high speeds approaching or even exceeding 90% of the speed of light. This capability is crucial for space applications where traditional mirrors would fail due to the redshifted light falling outside their reflective range. The low-emissivity coating is applied to the reflecting surface in certain embodiments of the invention. Its purpose is to minimize the emission of thermal radiation from the highly transparent retro-reflective sheet 100, thereby enhancing its ability to reflect incoming thermal radiation effectively.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principles of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

It will readily be apparent that numerous modifications and alterations can be made to the processes described in the foregoing examples without departing from the principles underlying the invention, and all such modifications and alterations are intended to be embraced by this application.

The claimed invention is:

1. A highly transparent retro-reflective sheet for broad-spectrum light reflection, comprising:
a sheet body made of a highly transparent material, wherein said sheet body having a minimum thickness to minimize a length of a light path for preventing input light absorption;
an optical structure surface disposed on one side of the sheet body, wherein said optical structure surface is configured to pass an input light from one or more light sources; and
a reflecting surface disposed opposite to said optical structure surface, wherein said reflecting surface is configured to totally internally reflect the input light passed through the optical structure surface across a broad spectrum as a reflected light, thereby achieving retro-reflectivity with a minimum of light absorption by said highly transparent retro-reflective sheet.

2. The highly transparent retro-reflective sheet of claim 1, wherein the highly transparent material is a low OH fused silica.

3. The highly transparent retro-reflective sheet of claim 1, wherein the highly transparent material includes at least one of a Barium Fluoride (BaF2), Cadmium Telluride (CdTe), Calcium Fluoride (CaF2), Fused Silica (SiO2), Gallium Arsenide (GaAs), Germanium (Ge), Intrinsic Silicon (Si), IR Polymer, Thallium Bromo-Iodide (KRS-5), Lead Fluoride (PbF2), Magnesium Fluoride (MgF2), Magnesium Oxide (MgO), N-BK7, Potassium Bromide (KBr), Sapphire (Al2O3), Sodium Chloride (NaCl), zirconium-barium-lanthanum-aluminum fluoride (ZBLAN), Zinc Oxide (ZnO), Zinc Selenide (ZnSe), Zinc Sulphide (ZnS), and any other solid material with similarly broadband high transparency.

4. The highly transparent retro-reflective sheet of claim 1, wherein the reflecting surface comprises a plurality of reflecting elements.

5. The highly transparent retro-reflective sheet of claim 4, wherein each reflecting element comprises at least one of a corner cube structure, a trihedral pyramid structure, and geometrical structures that are capable of achieving retro-reflectivity.

6. The highly transparent retro-reflective sheet of claim 4, wherein the plurality of reflecting elements is patterned on the reflecting surface of the sheet body using one or more methods including a cutting method, an etching method such as lithographic wet or dry etching, a pressing method, an imprinting method, a molding method, forming from the molten or semifluid state such as forming warm glass above its glass transition temperature, and any form of vapor deposition methods including Physical Vapor Deposition (PVD), Chemical Vapor Deposition (CVD), Plasma-Enhanced Chemical Vapor Deposition (PECVD), Metal Organic Chemical Vapor Deposition (MOCVD), and similar methods.

7. The highly transparent retro-reflective sheet of claim 1, wherein the highly transparent retro-reflective sheet further may comprise a low-emissivity coating applied to the reflecting surface, specifically designed to minimize thermal radiant emission from the reflecting surface, thereby achieving an asymmetrical emission of thermal radiation without significantly enhancing the reflectivity of the highly transparent retro-reflective sheet.

8. The highly transparent retro-reflective sheet of claim 1, wherein the broad spectrum includes wavelengths ranging from deep ultraviolet (shorter wavelengths) to far infrared (longer wavelengths).

9. A highly transparent retro-reflective sheet for broad-spectrum light reflection, comprising:
a sheet body made of a highly transparent material, wherein said sheet body having a minimum thickness to minimize a length of a light path for preventing input light absorption;
an optical structure surface disposed on one side of the sheet body, wherein said optical structure surface is configured to pass an input light from one or more light sources;
a reflecting surface disposed opposite to said optical structure surface, wherein said reflecting surface having a plurality of reflecting elements configured to totally internally reflect the input light passed through the optical structure surface across a broad spectrum as a reflected light, thereby achieving retro-reflectivity with a minimum of light absorption by said highly transparent retro-reflective sheet; and
a low-emissivity coating applied to the reflecting surface, wherein the low-emissivity coating is configured to minimize thermal radiant emission from the reflecting surface.

10. The highly transparent retro-reflective sheet of claim 9, wherein the highly transparent material is a low OH fused silica.

11. The highly transparent retro-reflective sheet of claim 9, wherein the highly transparent material includes at least one of a Barium Fluoride (BaF2), Cadmium Telluride (CdTe), Calcium Fluoride (CaF2), Fused Silica (SiO2), Gallium Arsenide (GaAs), Germanium (Ge), Intrinsic Silicon (Si), IR Polymer, Thallium Bromo-Iodide (KRS-5), Lead Fluoride (PbF2), Magnesium Fluoride (MgF2), Magnesium Oxide (MgO), N-BK7, Potassium Bromide (KBr), Sapphire (Al2O3), Sodium Chloride (NaCl), zirconium-barium-lanthanum-aluminum fluoride (ZBLAN), Zinc Oxide (ZnO), Zinc Selenide (ZnSe), Zinc Sulphide (ZnS), and any other solid material with similarly broadband high transparency.

12. The highly transparent retro-reflective sheet of claim 9, wherein each reflecting element comprises at least one of a corner cube structure, a trihedral pyramid structure, and geometrical structures that capable of achieving the retro-reflectivity.

13. The highly transparent retro-reflective sheet of claim 9, wherein the plurality of reflecting elements is patterned on the reflecting surface of the sheet body using one or more methods including a cutting method, an etching method such as lithographic wet or dry etching, a pressing method, an imprinting method, a molding method, forming from the molten or semifluid state such as forming warm glass above its glass transition temperature, and any form of vapor deposition methods including Physical Vapor Deposition (PVD), Chemical Vapor Deposition (CVD), Plasma-Enhanced Chemical Vapor Deposition (PECVD), Metal Organic Chemical Vapor Deposition (MOCVD), and similar methods.

14. The highly transparent retro-reflective sheet of claim 9, wherein the low-emissivity coating achieves an asymmetrical emission of thermal radiation by reducing the thermal radiant emission from the reflecting surface without significantly enhancing the reflectivity of the highly transparent retro-reflective sheet.

15. The highly transparent retro-reflective sheet of claim 9, wherein the broad spectrum includes wavelengths ranging from deep ultraviolet (shorter wavelengths) to far infrared (longer wavelengths).
